(19) United States
(12) Patent Application Publication
(10) Pub. No.: US 2026/0125037 A1
(43) Pub. Date: May 7, 2026

(54) AXLE INTEGRATED IMMOBILIZER SYSTEM

(71) Applicant: Dana Motion Systems Italia S.R.L., Reggio Emilia (IT)

(72) Inventor: Riccardo MORSELLI, Modena (IT)

(21) Appl. No.: 18/934,819

(22) Filed: Nov. 1, 2024

(51) Int. Cl. B60T 13/66; B60R 25/04; B60R 25/08; B60T 1/00; B60T 8/17; B60T 13/22; B60T 13/68

(52) U.S. Cl. CPC B60T 13/662; B60R 25/04; B60R 25/08; B60T 1/005; B60T 8/17; B60T 13/22; B60T 13/686; B60T 2220/00

(57) ABSTRACT

Systems and methods are disclosed for an off-highway (OH) machine or vehicle immobilization system, that when activated, prevents the OH machine from being moved, as an anti-theft device. The vehicle immobilization system relies on a Spring Applied Hydraulic Release (SAHR) brake that is integrated into an axle of the OH machine. Without oil pressure, the SAHR brake is engaged, and wheels of the OH machine or vehicle cannot rotate. The SAHR brake cannot be disengaged except by applying pressure in a hydraulic line of the SAHR brake. The hydraulic line passes through an electric immobilizer valve that is integrated inside the axle. If the valve is closed (e.g., no oil flow through the valve), the SAHR cannot be disengaged, and the vehicle cannot move. When the valve is opened, oil flows through the valve and the SAHR is disengaged, allowing movement.

### TECHNICAL FIELD

The present disclosure relates to vehicle anti-theft devices.

### BACKGROUND AND SUMMARY

Off-highway (OH) vehicles and machines such as back hoes, overhead cranes, etc., are often left in remote areas with limited surveillance, making them an easy target for theft. Machines with anti-theft features have access to discounted insurance. However, to qualify for the discounted insurance, an OH machine must have an anti-theft certification. To get the anti-theft certification, the OH machine must withstand theft attacks such as electronic control unit (ECU) replacement, hydraulic/mechanical modification, re-routing electrical wires, etc., for a threshold duration, such as 60 minutes. To ensure that an easy modification or replacement is not sufficient to move the vehicle, original equipment manufacturers (OEMs) often frame ECUs in heavy frames, which make vehicle maintenance more difficult and increase a cost of an immobilizer function. OH engines may not be equipped with the immobilizer function, where if the OH vehicle is disconnected from a controller area network (CAN), the engine may be started in a recovery mode and the vehicle can be moved and stolen. Thus, there is a need for a robust and inexpensive immobilization solution for OH vehicles that covers a variety of circumstances. For example, a rental company could use an immobilization system to lock an OH machine and prevent operation when the rental has expired, via a telematics system.

In one example, the issues described above may be addressed by an immobilization system for an off-highway vehicle, comprising a valve positioned on a hydraulic line supplying pressurized oil to a Spring Applied Hydraulic Release (SAHR) braking mechanism of the vehicle, such that when actuated to a closed position, prevents a pressure of the oil from releasing the SAHR braking mechanism, immobilizing the vehicle; wherein the valve is integrated inside an axle of the vehicle. The valve may be actuated to the closed position after the vehicle is parked, for example, when an emergency brake is engaged, at a time when a pressure of the oil is below a threshold for releasing the SAHR braking mechanism. Once the valve is closed, the SAHR braking mechanism cannot be released, and the vehicle is immobilized. When the vehicle is restarted, the valve may be actuated to an open position, thereby allowing the pressurized oil to release the SAHR braking mechanism, freeing the vehicle to move. A coded electrical signal may be used to open the valve, to prevent unauthorized intervention into the system. In this way, a robust way to immobilize a vehicle is provided that is based on a simple electrical circuit. The valve is physically protected from attacks by integrating the valve and an electronic control board that controls the valve into the axle.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings, in which:

FIG. 1 is a block diagram of a prophetic example of an OH vehicle;

FIG. 2 is an illustration of an axle of the OH vehicle including an exemplary immobilization system;

FIG. 3 is a first schematic diagram of an exemplary immobilizer hydraulic valve of the immobilization system;

FIG. 4 is a second schematic diagram of the exemplary immobilizer hydraulic valve;

FIG. 5 is a schematic diagram of the immobilization system including the immobilizer hydraulic valve;

FIG. 6 is a flowchart illustrating an exemplary method for unlocking the immobilization system;

FIG. 7 is a first timing diagram illustrating a first exemplary sequence of events during unlocking the immobilization system in a first condition; and

FIG. 8 is a second timing diagram illustrating a second exemplary sequence of events unlocking the immobilization system in a second condition.

### DETAILED DESCRIPTION

Systems and methods are proposed herein for an off-highway (OH) machine or vehicle immobilization system, also referred to herein as an immobilizer, that when activated, prevents the OH machine from being moved, as an anti-theft device. Current OH machines may be operable without key recognition, meaning, using a key that is valid for a plurality of machines. As a result, if a key is not available, an OH machine may be started via an easy workaround. OH vehicles are typically not equipped with an immobilizer function, and an OH vehicle may be easily moved and stolen by disconnecting the OH vehicle from a vehicle network and starting an engine of the OH vehicle in recovery mode. Aftermarket immobilizer kits can be installed, but such solutions are currently not robust enough to provide significant additional security, and do not connect with telematics systems.

The proposed vehicle immobilization system resolves these issues using a Spring Applied Hydraulic Release (SAHR) brake that is integrated into an axle of the OH machine. Without oil pressure, the SAHR brake is engaged, and wheels of the OH machine or vehicle cannot rotate. The SAHR brake cannot be disengaged except by applying pressure in a hydraulic line of the SAHR brake, although, in the event of an emergency, the SAHR brake can be released by pressurizing the SAHR hydraulic line using an external (e.g., manual) pump.

The vehicle immobilization system comprises an electric immobilizer valve that is integrated inside the axle. The hydraulic line passes through the electric immobilizer valve. If the valve is closed (e.g., no oil flow through the valve), the SAHR cannot be disengaged, and the vehicle cannot move. When the valve is opened, oil flows through the valve and the SAHR is disengaged, allowing movement. The immobilizer valve does not interfere with vehicle safety functions, and is actuated by a simple electronic circuit. For example, two wires can be used to connect the axle-integrated immobilizer valve with an ECU of the vehicle. Because the elements that provide the immobilization function are integrated inside the axle, a strong shielding is provided to deter access, within a same envelope as currently being used.

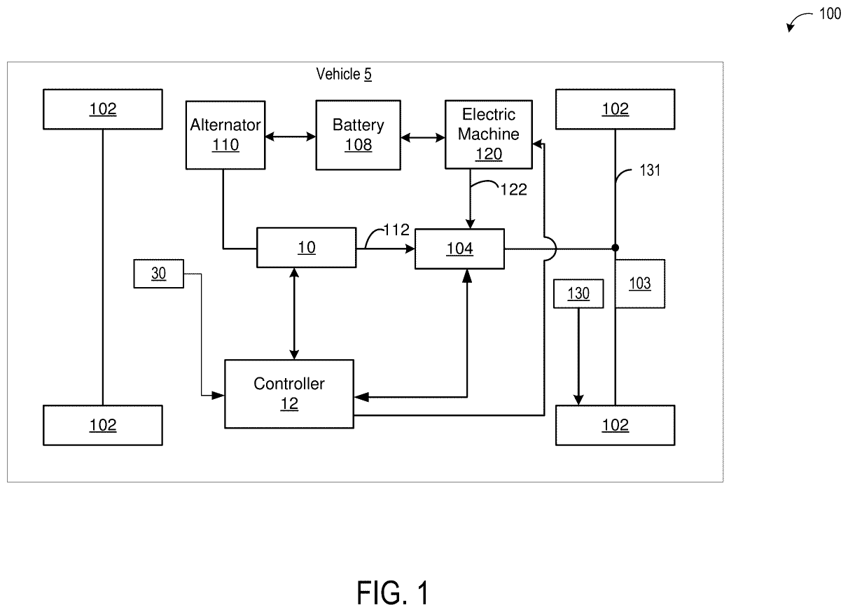

Referring now to FIG. 1, an example OH vehicle 5 is shown. In various examples, OH vehicle 5 is a hybrid vehicle with multiple sources of torque available to one or more vehicle wheels 102. In other examples, OH vehicle 5 is a conventional vehicle with only an engine, or an electric vehicle with only electric machine(s). In the example shown, OH vehicle 5 includes an internal combustion engine 10 and an electric machine 120. Electric machine 120 may be a motor or a motor/generator. Electric machine 120 may be configured to utilize or consume a different energy source than engine 10. For example, engine 10 may consume a liquid fuel (e.g., gasoline) to produce an engine output while electric machine 120 may consume electrical energy to produce a motor output. As such, the OH vehicle 5 may be referred to as a hybrid electric vehicle (HEV).

In a non-limiting embodiment, electric machine 120 receives electrical power from a battery 108 to provide torque to vehicle wheels 102. Engine 10 and electric machine 120 are connected to the vehicle wheels 102 via a transmission 104. Transmission 104 may be a gearbox, a planetary gear system, or another type of transmission.

OH vehicle 5 may utilize a variety of different operational modes depending on operating conditions encountered. Some of these modes may enable engine 10 to be maintained in an off state where combustion of fuel at the engine is discontinued. For example, under select operating conditions, electric machine 120 may propel the vehicle via transmission 104 as indicated by arrow 122 while engine 10 is deactivated. The select operating conditions may include a stopped condition, wherein the engine 10 may be maintained in an off state while the OH vehicle 5 is not moving. When the OH vehicle 5 begins to accelerate, the OH vehicle 5 may be propelled by electric machine 120, or engine 10 may be switched to an on state and may propel the OH vehicle 5.

During other operating conditions, electric machine 120 may be operated to charge an energy storage device such as the battery 108. For example, electric machine 120 may receive wheel torque from transmission 104 as indicated by arrow 122 where the motor may convert the kinetic energy of the vehicle to electrical energy for storage at battery 108. Thus, electric machine 120 may provide a generator function in some embodiments. However, in other embodiments, alternator 110 may instead receive wheel torque from transmission 104, or energy from engine 10, where the alternator 110 may convert the kinetic energy of the vehicle to electrical energy for storage at battery 108.

During still other operating conditions, engine 10 may be operated by combusting fuel received from a fuel system (not shown in FIG. 1). For example, engine 10 may be operated to propel the vehicle via transmission 104 as indicated by arrow 112 while electric machine 120 is deactivated. During other operating conditions, both engine 10 and electric machine 120 may each be operated to propel the vehicle via transmission 104 as indicated by arrows 112 and 122, respectively. A configuration where both the engine and the motor may selectively propel the vehicle may be referred to as a parallel type vehicle propulsion system. Note that in some embodiments, electric machine 120 may propel the vehicle via a first drive system and engine 10 may propel the vehicle via a second drive system.

Operation in the various modes described above may be controlled by a controller 12. During operation of OH vehicle 5, controller 12 may receive commands from a operator of OH vehicle 5. Controller 12 may receive a request for torque via an accelerator pedal 30, for example, when the operator wishes to accelerate the vehicle. The operator may initiate an acceleration of the vehicle by applying a pressure on accelerator pedal 30. Controller 12 may command engine 10 or electric machine 120 to supply the requested torque to perform the acceleration, based on a position of accelerator pedal 30.

When OH vehicle 5 is parked, one or more wheels 102 may be mechanically locked by a parking brake 130. Additionally, OH vehicle 5 may include an immobilization system (immobilizer) 103, which may immobilize OH vehicle 5 and further prevent one or more wheels 102 from moving, as an additional security measure. Immobilizer 103 may be activated manually by the operator, or automatically, at a time of parking OH vehicle 5, or activated remotely by an owner of OH vehicle 5 via a telematics system. For example, the owner may rent OH vehicle 5 to a client, and when a rental period of OH vehicle 5 has ended, the owner may remotely activate immobilizer 103 to ensure that OH vehicle 5 cannot be moved outside the rental period or moved to a different location.

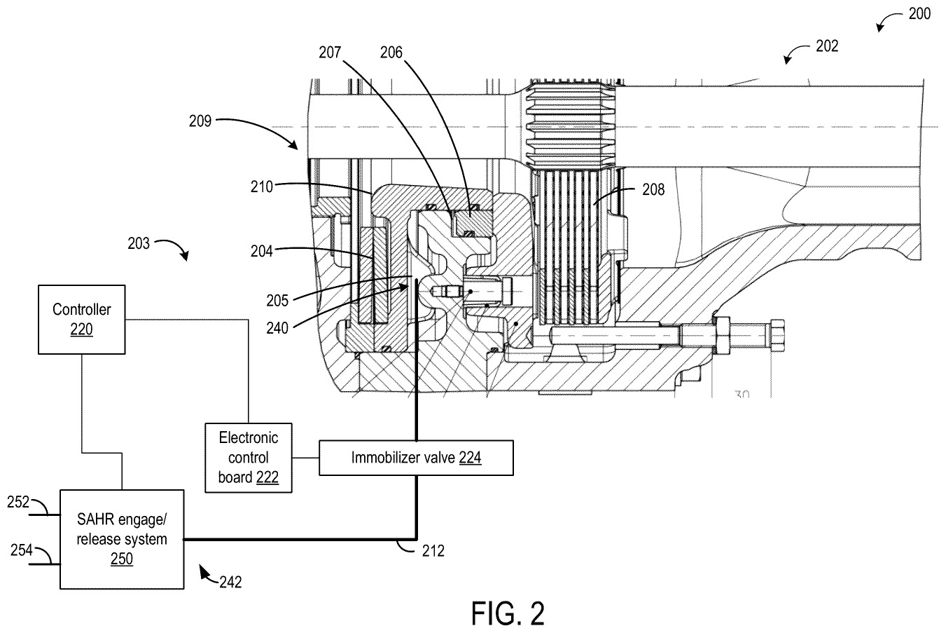

Immobilizer 103 may be integrated into and positioned within an axle 131 of OH vehicle 5. By integrating immobilizer 103 into axle 131, immobilizer 103 may be more shielded from an attempted theft. Immobilizer 103 is described in greater detail below in reference to FIGS. 2-10.

Turning to FIG. 2, a schematic diagram 200 shows an exemplary vehicle immobilization system 203 that is integrated into an axle 202 of an OH vehicle, such as OH vehicle 5 of FIG. 1. As such, immobilization system 203 may be a non-limiting example of immobilizer 103. Axle 202 is drawn approximately to scale. It should be appreciated that in other embodiments, immobilization system 203 may be integrated into more than one axle of the OH vehicle.

Axle 202 includes a SAHR braking mechanism 209, which may be a parking brake or emergency brake (e.g., parking brake 130) of the OH vehicle. SAHR braking mechanism 209 comprises a plurality of brake disks 208, a SAHR brake piston 210, a service brake piston 206, and a SAHR brake spring 204. The plurality of brake disks 208 are engaged to lock wheels of the OH vehicle (e.g., wheels 102) by an SAHR brake piston 210. Brake disks 208 may include four (two per side), or six (three per side), or eight (four per side), or a different number of brake disks. Brake disks 208 may also be engaged via a service brake piston 206, which may be actuated during operation of the OH vehicle when a brake pedal is pressed. That is, the same braking mechanism may be used for both the parking brake and the service (pedal) brake. Service brake piston 206 may be actuated hydraulically via a hydraulic actuation port 207.

An SAHR brake spring 204 pushes SAHR brake piston 210 against brake disks 208, such that brake disks 208 are normally engaged. To disengage brake disks 208 and unlock one or more wheels of the OH vehicle (e.g., to allow the wheels to rotate), an oil pressure is applied to SAHR brake piston 210, releasing the brake disks 208. The oil pressure is provided via a hydraulic line 212, which is coupled to SAHR brake piston 210 at an internal SAHR hydraulic release port 205 at a first end 240 of hydraulic line 212. A second end 242 of hydraulic line 212 is coupled to an SAHR engage/release system 250, which controls the pressure of the oil in hydraulic line 212. Inputs into SAHR engage/release system 250 may include a pressure line 252 and a tank line 254 to an oil tank (not depicted in FIG. 2). Engagement of brake disks 208 may occur when the oil pressure increases above a threshold pressure (e.g., 15 bar, for example). SAHR engage/release system 250 is controlled by a controller 220, which may be a non-limiting example of controller 12 of OH vehicle 5 of FIG. 1.

It should be noted that in case of a failure in the hydraulic system during operation of the OH vehicle, meaning, a leakage that causes the oil pressure in hydraulic line 212 to decrease below a threshold pressure, service brake piston 206 would be inoperable, and the service brake would not work. However, in such cases, brake disks 208 advantageously engage “automatically”, due to the pressure decrease.

Immobilization system 203 relies on SAHR braking mechanism 209 to lock the wheels of the OH vehicle, thereby immobilizing the OH vehicle. Immobilization system 203 includes an electronic control board 222 and an immobilizer valve 224 positioned on hydraulic line 212. Both electronic control board 222 and immobilizer valve 224 are integrated inside axle 202 and are therefore protected by structural components and shielding of axle 202. Immobilizer valve 224 may be actuated by electronic control board 222 to an open position, where the oil is allowed to flow through immobilizer valve 224, or a closed position, where the oil is prevented from flowing through immobilizer valve 224. When brake disks 208 are engaged (e.g., when the parking brake is engaged by the operator), the oil pressure at SAHR brake spring 204 is below a threshold pressure for releasing brake disks 208. Thus, when immobilizer valve 224 is actuated to the closed position while brake disks 208 are engaged, the oil pressure cannot be increased, and brake disks 208 will remain locked into place. When immobilizer valve 224 is actuated to the open position, the oil pressure at SAHR brake spring 204 may be increased to release brake disks 208. When immobilizer valve 224 is actuated to the open position, the oil pressure is regulated by SAHR engage/release system 250.

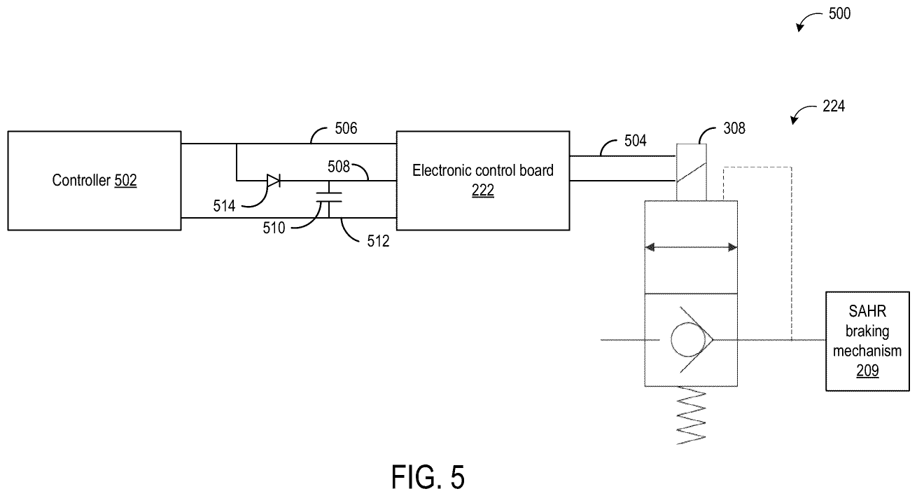

Electronic control board 222 may actuate immobilizer valve 224 based on an electric signal sent from controller 220. In some examples, controller 220 may command electronic control board 222 to open immobilizer valve 224 in response to an operator input. For example, the operator may select a control element on a dashboard of the OH vehicle to activate immobilization system 203, and controller 220 may command electronic control board 222 to open immobilizer valve 224 in response to the immobilization system 203 being activated. In other examples, immobilization system 203 may be activated automatically, for example, in response to the parking brake being engaged by the operator. In still other examples, immobilization system 203 may be activated manually or automatically in a remote fashion over a wireless network, by an owner or manager of the OH vehicle. In some examples, immobilization system 203 may be activated in response to at a plurality of conditions, such as, for example, the parking brake being engaged and the operator selecting a control element, or the parking brake being engaged and a remote signal for activation being received at the vehicle. The actuation of immobilizer valve 224 by electronic control board 222 is described in greater below in reference to FIG. 5.

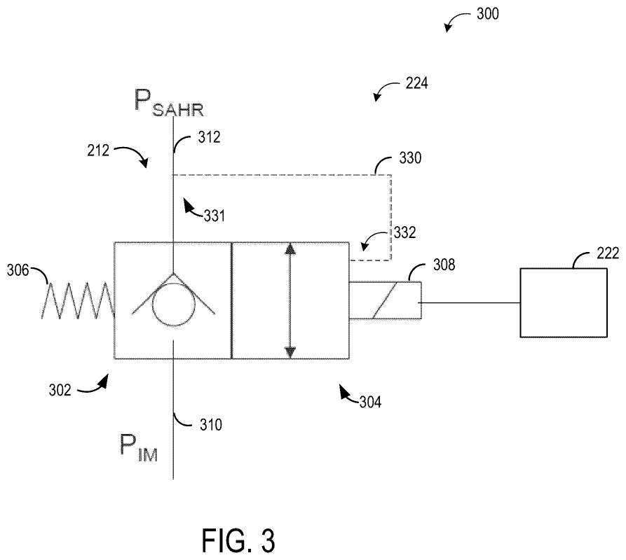

Referring now to FIG. 3, a first circuit diagram 300 is shown of immobilizer valve 224 of FIG. 2 and/or immobilization system 103 of FIG. 1. In FIG. 3, immobilizer valve 224 is shown in a closed or stable off state (e.g., state=0).

Immobilizer valve 224 is positioned on hydraulic line 212, where pressurized oil enters immobilizer valve 224 from the SAHR engage/release system via a first section 310 of hydraulic line 212, with a first pressure P_{IM}. A second section 312 of the hydraulic line connects immobilizer valve 224 with SAHR braking mechanism 209 of the OH vehicle, as described above in reference to FIG. 2, where oil may flow to the SAHR braking mechanism with a second pressure P_{SAHR}.

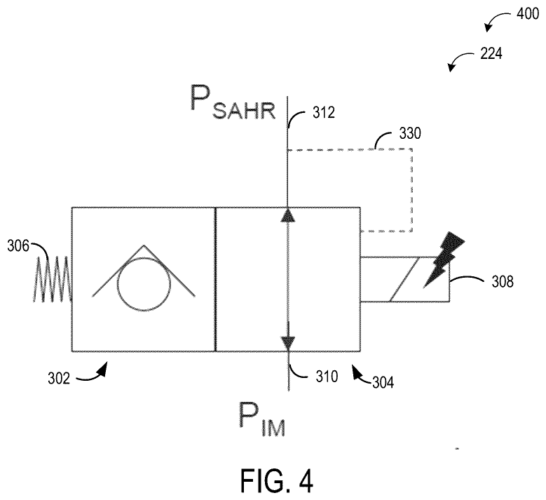

In the depicted embodiment, immobilizer valve 224 is a spool valve that has a first chamber 302 and a second chamber 304. Immobilizer valve 224 may be normally positioned on the hydraulic line by a spring 306, such that first chamber 302 is positioned between sections 310 and 312. Pressurized oil in the hydraulic line may not pass through first chamber 302. Immobilizer valve 224 may be actuated by a solenoid 308, based on a current transmitted from electronic control board 222. When solenoid 308 is energized by the current, solenoid 308 may push immobilizer valve 224 against spring 306, such that second chamber 304 is positioned between sections 310 and 312. Second chamber 304 may allow the pressurized oil to pass from first section 310 to second section 312 of the hydraulic line. Thus, when solenoid 308 is energized by the current, immobilizer valve 224 is switched to an open state. The open state is shown in FIG. 4.

In the closed state depicted in FIG. 3, the pressurized oil is stopped by immobilizer valve 224, and does not flow through section 312 of the hydraulic line. That is, in the closed state, the solenoid current is 0, and the SAHR braking mechanism is engaged. P_{SAHR} is less than a threshold pressure Pₜₕ at which the SAHR braking mechanism is disengaged, regardless of P_{IM}. An additional advantage of immobilizer valve 224 is that, because P_{SAHR} can never be greater than P_{IM}, vehicle safety features that are that are unrelated to the immobilization system based on the automatic engagement of the SAHR brake with the release of hydraulic pressure are preserved, with no changes or effect on vehicle safety.

First circuit diagram 300 includes a second hydraulic line 330 between line 312 and immobilizer valve 224, which may be a smaller hydraulic line than line 312. A first end 331 of second hydraulic line 330 is fluidly coupled to line 312 upstream of immobilizer valve 224. A second end 332 of hydraulic line 330 is hydraulically coupled to second chamber 304, such that oil pressure in line 312 may be applied to second chamber 304. When the pressure in line 312 increases above a threshold pressure, a corresponding pressure increase in second hydraulic line 330 pushes first chamber 302 and second chamber 304 against spring 306 (e.g., to the left in FIG. 3). As a result of the oil pressure, immobilizer valve 224 becomes “latched” in the open state, where immobilizer valve 224 cannot close again until the pressure in line 312 and second hydraulic line 330 decrease below the threshold pressure. Without second hydraulic line 330, the position of immobilizer valve 224 would depend on the solenoid current alone. Immobilizer valve 224 may close when the solenoid current is turned ON, and if the pressure in 332 is above a threshold, the valve will remain in the open position even if the solenoid current goes OFF (latched status).

The latching of immobilizer valve 224 has multiple advantages. First, when the park brake is opened (high pressure in 312 and 330), the solenoid current can turn OFF without closing valve 224. As a result, once immobilizer valve 224 is unlocked (current ON), there may be no need to keep the current ON to keep the valve open, which saves energy. Additionally, from a safety standpoint, once the valve 224 is in “latched status”, the park brake cannot accidentally close, for example, due to a failure in the electric supply. Further, immobilizer valve 224 is prevented from returning to the initial closed position unless the pressure in section 310 is below a threshold, meaning, when the operator wants to engage the park brake or in case of a hydraulic failure, exactly as it is in current vehicles.

FIG. 4 shows a second circuit diagram 400 of immobilizer valve 224 in the open state. The open state may be a temporary-on state (e.g., state=1). When solenoid 308 is energized, immobilizer valve 224 is pushed against spring 306, such that sections 310 and 312 are aligned with second chamber 304. The pressurized oil may then flow from section 310 through immobilizer valve 224 into section 312 of the hydraulic line. In the open state, the solenoid current is greater than zero, and the SAHR braking mechanism is controlled by the SAHR engage/release system. As such P_{SAHR} and P_{IM} may vary, and a state of the SAHR braking mechanism depends on P_{SAHR}.

While solenoid 308 is energized, P_{SAHR} may be increased to the threshold pressure Pₜₕ by the SAHR engage/release system 250. When P_{SAHR} is greater than the threshold pressure Pₜₕ, immobilizer valve 224 may be in a stable-on state (e.g., state 2), where the solenoid current is no longer relied on to maintain immobilizer valve 224 in the open state, as described above. The solenoid current may then be reduced to zero (or any other value), and the state of the SAHR braking mechanism is controlled by the SAHR engage/release system 250, depending on P_{SAHR}. If P_{SAHR} is greater than the threshold pressure Pₜₕ, the SAHR braking mechanism is disengaged. If P_{SAHR} is less than the threshold pressure Pₜₕ, the SAHR braking mechanism is engaged. When P_{SAHR} is less than the threshold pressure Pₜₕ and the solenoid current is zero, immobilizer valve 224 is returned to the stable-off state depicted in FIG. 3.

Referring now to FIG. 5, a control diagram 500 shows a series of connections by which immobilizer valve 224 is actuated by a controller 502 of the OH vehicle, which may be controller 220 of FIG. 2 and/or controller 12 of FIG. 1, or a different controller. Immobilizer valve 224 is actuated by solenoid 308, which may receive a current via a solenoid command line 504 with electronic control board 222. Electronic control board 222 may be powered via a power supply positive line 508, which may be separated from a power supply ground line 512 by a capacitor 510. During a wake-up phase of electronic control board 222, capacitor 510 may be charged to supply power to electronic control board 222.

After electronic control board 222 is powered, electronic control board 222 may receive coded signals from controller 502, which may be decoded at electronic control board 222. Controller 502 may generated the coded signals by switching a current transmitted by controller 502 via a coded signal line 506 on and off in a predetermined (e.g., coded) sequence, where the coded sequence represents an electronic unlock code for disengaging SAHR braking mechanism 209. In various examples, a diode 514 may be used to protect the coded signal line 506 from a current generated by capacitor 510 used to power electronic control board 222.

The unlock code may be decoded at electronic control board 222. If the unlock code is valid, electronic control board 222 may transmit a current to solenoid 308 via solenoid command line 504 to energize solenoid 308, thereby disengaging braking mechanism 209 as described above in reference to FIG. 4. If the unlock code is invalid, electronic control board 222 may not transmit the current to solenoid 308 via solenoid command line 504. Solenoid 308 will not be energized, and braking mechanism 209 will remain engaged.

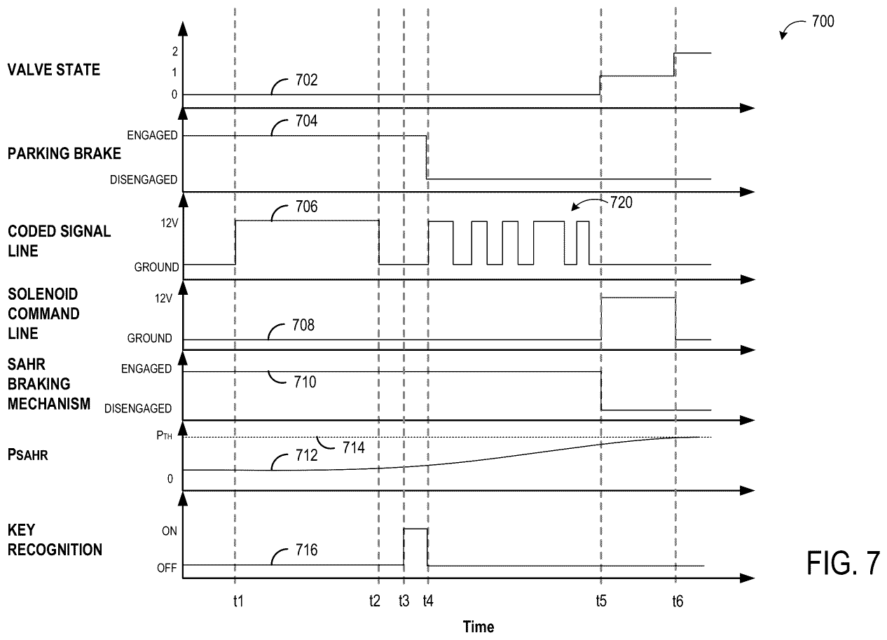

In various embodiments, the unlock code may comprise a sequence of electric signals that are transmitted by varying the current transmitted over coded signal line 506. For example, diode 514 may be switched on for a first duration, and the voltage difference at capacitor 510 may generate a first current during the first duration. Diode 514 may then be switched off for a second duration, where no current is generated during the second duration. Diode 514 may then be switched on for a third duration, and the voltage difference at capacitor 510 may generate a second current during the third duration, and so on, until a predetermined sequence of the electric signals has been completed. The duration of each electrical signal may be the same, or different. Thus, the durations of the electrical signals included in the sequence may be checked against a predetermined sequence of durations stored in a memory of the electronic control board to validate the unlock code. If the durations of the electrical signals included in the sequence are different from the durations of the predetermined sequence, the unlock code may not be valid. The unlock code is described in greater detail below in reference to FIG. 7.

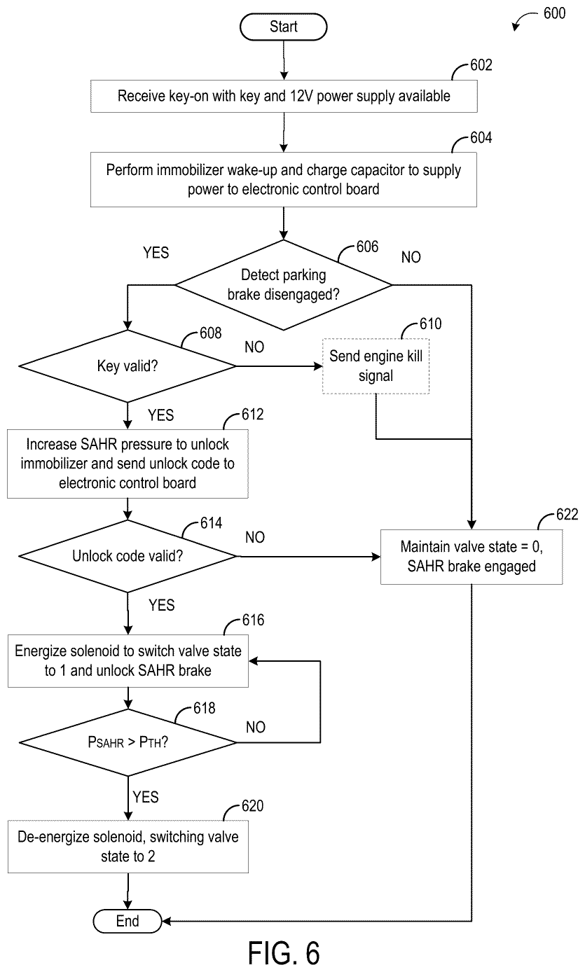

Referring now to FIG. 6, an exemplary method 600 is shown for unlocking an immobilization system, such as immobilization system 203, of an OH vehicle such as OH vehicle 5 of FIG. 1. Method 600 may be performed on the OH vehicle after the immobilization system has been used to immobilize the OH vehicle by locking one or more wheels of the OH vehicle. For example, the immobilization system may be used to lock the one or more wheels when a parking brake of the OH vehicle is engaged, either manually by an operator of the OH vehicle or automatically in response to the engagement of the parking brake. Alternatively, in some embodiments, the immobilization system may be activated remotely to lock the one or more wheels, via a telematics system and a wireless network.

When the immobilization system is used to lock the one or more wheels, an immobilizer valve of the immobilization system (e.g., valve 224) may be actuated to a closed position (e.g., state=0) after the OH vehicle is switched off. When the vehicle is switched off, a pressure P_{SHAR} applied to a SAHR braking mechanism of the OH vehicle decreases below a threshold pressure P_{TH} that releases the SAHR braking mechanism, and the SAHR braking mechanism engages. The engagement of the SAHR braking mechanism is maintained by the immobilization valve. When the immobilization system is unlocked, the immobilizer valve may be actuated to a temporary-open position (e.g., state 1), and the SAHR braking mechanism may be disengaged, allowing the one or more wheels of the OH vehicle to rotate and allowing the OH vehicle to move. When the pressure P_{SHAR} applied to the SAHR braking mechanism increases above the threshold pressure P_{TH}, the immobilizer valve may be latched in a stable-on open position (e.g., state 2), as a result of oil pressure in second hydraulic line 330 of FIGS. 3 and 4.

In various embodiments, method 600 may be executed by a controller of the vehicle, such as controller 12 of OH vehicle 5. In other embodiments, some or all of the steps of method 600 may be performed by a different controller other than controller 12. For example, in some embodiments, one or more steps of method 600 may be performed by a first electronic control unit (ECU) of the vehicle (e.g., controller 12), and one or more steps of method 600 may be performed by a second, different ECU, such as an electronic control board of the OH vehicle (e.g., electronic control board 222). The immobilization system and the electronic control board may be integrated into an axle of the OH vehicle, as described above in reference to FIGS. 1-2.

Method 600 begins at 602 where method 600 includes receiving a key-on signal with a key of the OH vehicle. The key-on signal may be received as a result of an operator of the OH vehicle switching on an ignition of the OH vehicle. When the key-on signal is received, the controller may confirm that a 12V power supply is available. If no 12V power supply is available, method 600 ends.

At 604, method 600 includes performing an immobilizer wake-up routine by charging a capacitor (e.g., capacitor 510) to supply power to the electronic control board, which controls the immobilizer valve. The capacitor may be charged from the 12V power supply.

At 606, method 600 includes determining whether a disengagement of a parking brake is detected. If at 606 the disengagement of the parking brake is not detected, method 600 proceeds to 622. At 622, method 600 includes maintaining the immobilizer valve in the closed state (0), with the SAHR brake engaged.

Alternatively, if at 606 the disengagement of the parking brake is detected, method 600 proceeds to 608. At 608, method 600 includes determining whether the key is recognized as valid. In various embodiments, a small electronic (e.g. RFID) chip may be included in the key and read by a rocker switch via a special round antenna in accordance with currently known techniques. The key is recognized if a first code read through the antenna corresponds to a second code stored in a memory of the vehicle. If the key is not recognized as valid, method 600 proceeds to 610.

At 610, method 600 optionally includes, if a CAN bus of the engine is connected, sending an engine kill signal to disable an engine of the OH vehicle. Disabling the engine may be performed as a safeguard, in addition to maintaining the OH vehicle immobile via the immobilization system. Method 600 then proceeds to 622, where the immobilizer valve is maintained in the closed state (0), with the SAHR brake engaged.

If the engine CAN bus is disconnected as a result of an attempted theft, the engine may be restarted in recovery mode. In such cases, if a transmission ratio of the OH vehicle is sufficient, the SAHR braking mechanism may not be powerful enough to maintain the one or more wheels immobile, and the one or more wheels may rotate despite the engagement of the SAHR braking mechanism. To prevent a theft under such circumstances, one or more alternative actions may be taken. If a transmission of the OH vehicle has electronic control, such as a simple power shuttle, the transmission can be locked in a neutral gear when there is no communication with the engine via the CAN bus. In such cases, no tractive torque will be provided to the axle. Alternatively, the SAHR braking mechanism may be configured to have a first braking torque that is higher than a second torque applied to the axle through the transmission, and/or higher than a maximum torque permissible by at least one element of the axle (e.g., driveshaft, sun gear, pinion, etc.). In such cases, if the SAHR braking mechanism is forced to rotate, the at least one element of the axle may break, preventing the OH vehicle from moving.

Returning to 608, if the key is recognized as valid, method 600 proceeds to 612. At 612, method 600 includes increasing the SAHR pressure in preparation for unlocking the immobilization system, and sending an unlock code to the electronic control board. In various examples, the unlock code may be a predetermined sequence of electric signals of varying durations, as described above.

At 614, method 600 includes determining whether the unlock code is valid. The unlock code may be invalid in an attempted theft of the OH vehicle, for example, if a malicious user hacks into a control system of the OH vehicle. In some examples, the electronic control board may compare the durations (and/or other characteristics) of each electric signal in the received sequence of electric signals with durations of the electrical signals of the predetermined sequence. If the durations and/or characteristics match, the unlock code may be presumed to be valid. If the durations and/or characteristics do not match, the unlock code may be an invalid code.

If the unlock code is not a valid code, method 600 proceeds to 622, where the valve is maintained in the closed state and the SAHR brake mechanism is maintained in the engaged state. The OH vehicle cannot move. Alternatively, if the unlock code is a valid code, method 600 proceeds to 616.

At 616, method 600 includes energizing a solenoid (e.g., solenoid 308) of the immobilization valve to actuate the immobilization valve to the temporary-on, open state (e.g., state=1). When the immobilization valve is actuated to the open state, the SAHR brake mechanism is disengaged, and the one or more wheels of the OH vehicle are unlocked.

At 618, method 600 includes determining whether the pressure P_{SHAR} applied to the SAHR braking mechanism has increased above the threshold pressure P_{TH}. If P_{SHAR} is greater than P_{TH}, method 600 proceeds to 620. At 620, the solenoid is de-energized, and the immobilizer valve is maintained in the stable-on open position (e.g., state 2). In the stable-on open position, the engagement of the SAHR braking mechanism is controlled by an SAHR engage/release system of the OH vehicle (e.g., SAHR engage/release system 250), and method 600 ends. If P_{SHAR} is not greater than P_{TH}, method 600 proceeds back to 616, and the solenoid is maintained energized to hold the immobilizer valve open.

FIG. 7 is a first example timing diagram 700 showing a timing of a sequence of events/actions performed in accordance with method 600, in a first condition where the key is a valid key (e.g., not during an attempted theft of the OH vehicle). Timing diagram 700 shows plots 702, 704, 706, 708, 710, 712, and 716. Plot 702 indicates a state of the immobilizer valve, which may be one two, or three. Plot 704 indicates a state of the parking or emergency brake, which may be ENGAGED or DISENGAGED. Plot 706 indicates an amount and timing of a first current transmitted to the electronic control board via a coded signal line (e.g., coded signal line 506 of FIG. 5) as a result of a first applied voltage (e.g., 12 V), which may include an unlock code for unlocking the immobilization system. Plot 708 indicates an amount and timing of a second current transmitted to the solenoid via a solenoid command line (e.g., solenoid command line 504) as a result of a second applied voltage (e.g., 12V), which may energize the solenoid. Plot 710 indicates a state of the SAHR braking mechanism, which may be in an ENGAGED or DISENGAGED state. Plot 712 indicates an amount of pressure P_{SHAR} applied to the SAHR braking mechanism, where the pressure threshold P_{TH} is indicated by a dotted line 714. Plot 716 indicates a status of a key recognition task, during which a validity of a key used to start the OH vehicle is determined. The key recognition task may be ON when being performed, and OFF when not being performed. Dashed lines t1-t6 represent significant times in the sequence of actions/events.

At time t0, the immobilizer valve is in state 0 (closed or stable-off), and the parking brake is ENGAGED. The SAHR braking mechanism is ENGAGED, and the OH vehicle is immobile and cannot move.

At time t1, the first voltage is applied to the capacitor of the immobilization system to induce the first current in the coded signal line to power up the electronic control board. The first the first voltage may be applied as a result of an ignition of the OH vehicle being switched on with a key, for example. Between time t1 and t2, the capacitor is charged up, and at time t1, the wake-up phase of the electronic control board ends with the electronic control board powered up.

At time t3, and between time t3 and t4, the key recognition task is performed to determine the validity of the key used to switch on the ignition. In FIG. 7, the key is recognized as being valid.

At time t4, the disengagement of the parking brake is detected. In response to the disengagement of the parking brake and the key being recognized as valid, between time t4 and t5, an unlock code 720 is transmitted over the coded signal line, where unlock code 720 may include a sequence of electric signals of varying durations induced by switching the voltage applied to the coded signal line on and off (e.g., via diode 514). Concurrently, the pressure P_{SHAR} applied to the SAHR braking mechanism is increased in preparation for unlocking the immobilization system.

At time t5, the sequence of electronic signals of unlock code 720 ends. Unlock code 720 is received by the electronic control board, which checks durations (and/or other characteristics) of the electric signals of the sequence to determine whether unlock code 720 is valid. The durations of the electric signals are determined to match a predetermined sequence stored in a memory of the electronic control board, and unlock code 720 is validated.

In response to unlock code 720 being validated, the electronic control board applies the second voltage to the solenoid command line, which energizes the solenoid of the immobilizer valve. When the solenoid is energized, the immobilizer valve is switched to the temporarily open state (e.g., state=1). As a result of switching the immobilizer valve to the temporarily open state, the SAHR braking mechanism is DISENGAGED, allowing the one or more wheels to rotate and allowing the OH vehicle to move. Between time t5 and t6, the solenoid remains energized, and P_{SHAR} continues to increase.

At time t6, P_{SHAR} increases above the pressure threshold P_{TH} indicated by dotted line 714. As a result of P_{SHAR} increasing above P_{TH}, the application of the second voltage is stopped, terminating the current at the solenoid and de-energizing the solenoid. The immobilizer valve is switched to the stable-off open position (e.g., state=2), and the SAHR braking mechanism is controlled based on P_{SHAR}, by the SAHR engage/release system.

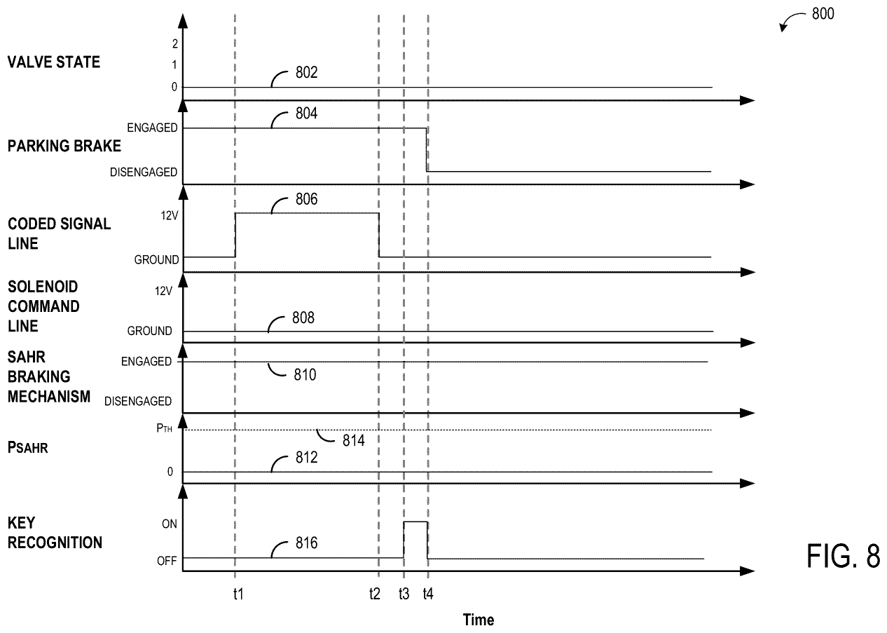

Referring now to FIG. 8, a second example timing diagram 800 shows a timing of a different sequence of events/actions performed in accordance with method 600, in a second condition where the key is not a valid key (e.g., during an attempted theft of the OH vehicle). Timing diagram 800 shows plots 802, 804, 806, 808, 810, 812, and 816. Plot 802 indicates a state of the immobilizer valve, which may be one two, or three. Plot 804 indicates a state of the parking or emergency brake, which may be ENGAGED or DISENGAGED. Plot 806 indicates an amount and timing of a first current transmitted to the electronic control board via a coded signal line (e.g., coded signal line 506 of FIG. 5) as a result of a first applied voltage (e.g., 12 V), which may include an unlock code for unlocking the immobilization system. Plot 808 indicates an amount and timing of a second current transmitted to the solenoid via a solenoid command line (e.g., solenoid command line 504) as a result of a second applied voltage (e.g., 12V), which may energize the solenoid. Plot 810 indicates a state of the SAHR braking mechanism, which may be in an ENGAGED or DISENGAGED state. Plot 812 indicates an amount of pressure P_{SHAR} applied to the SAHR braking mechanism, where the pressure threshold P_{TH} is indicated by a dotted line 814. Plot 816 indicates a status of a key recognition task, during which a validity of a key used to start the OH vehicle is determined. The key recognition task may be ON when being performed, and OFF when not being performed. Dashed lines t1-t4 represent significant times in the sequence of actions/events.

At time t0, the immobilizer valve is in state 0 (closed or stable-off), and the parking brake is ENGAGED. The SAHR braking mechanism is ENGAGED, and the OH vehicle is immobile and cannot move.

At time t1, the first voltage is applied to the capacitor of the immobilization system to induce the first current in the coded signal line to power up the electronic control board. The first the first voltage may be applied as a result of an ignition of the OH vehicle being switched on with the invalid key, for example. Between time t1 and t2, the capacitor is charged up, and at time t1, the wake-up phase of the electronic control board ends with the electronic control board powered up.

At time t3, and between time t3 and t4, the key recognition task is performed to determine the validity of the key used to switch on the ignition. In FIG. 8, the key is recognized as being invalid, where the attempted theft of the OH vehicle is detected.

At time t4, the disengagement of the parking brake is detected. However, as a result of the key being recognized as invalid, in contrast to timing diagram 700, no unlock code is sent on the coded signal line in response to the disengagement of the parking brake, and the pressure P_{SHAR} applied to the SAHR braking mechanism is not increased. As a result of not sending the unlock code, no current is induced in the solenoid command line, and the solenoid is not energized. As a result of the solenoid not being energized, the immobilizer valve remains in the closed state (e.g., state=0), and SAHR braking mechanism remains ENGAGED. Despite the parking brake being DISENGAGED, the one or more wheels of the OH vehicle are locked by the immobilization system, and the attempted theft is thwarted. As an additional safeguard, an engine kill signal may be sent to the engine, to ensure that the OH vehicle may not be operated even with the SAHR braking mechanism engaged.

Thus, a vehicle immobilization system is disclosed that relies on a SAHR brake integrated into an axle of the OH machine. The SAHR brake engages in the absence of sufficient oil pressure in a hydraulic line of the SAHR brake, locking wheels of the OH machine. The SAHR brake is disengaged by increasing the oil pressure above a threshold oil pressure. An electric immobilizer valve integrated into an axle of the OH machine may be electrically actuated to shut off or turn on a flow of oil in the hydraulic line. When the flow is shut off while the oil pressure is below the threshold oil pressure, the vehicle will be immobilized. The immobilization system may be unlocked by switching the immobilizer valve to an open position. The integrated immobilizer valve and SAHR brake are protected from physical access (e.g., during an attempted theft) by structural components and shielding of the axle, which are only minimally modified to include the components of the immobilization system. In this way, a robust anti-theft system is provided at low cost and low complexity, which may allow the OH machine to withstand theft attacks for a threshold duration demanded by an anti-theft certification to be eligible for discounted insurance, lowering operational costs of the OH machine. The same immobilization system can be applied to park locks, dog clutches, and/or other devices that rely on a disengagement of hydraulic pressure.

An additional advantage of the disclosed immobilization system is that a safety of the OH vehicle may be increased in comparison with other alternative security measures. The SAHR pressure is high when the vehicle is moving, so the valve cannot be closed. If the immobilizer valve is accidentally closed or stuck closed while the OH vehicle is standing still, the OH vehicle cannot be moved even with a recognized key, which does not create a safety risk. Alternatively, if the valve is accidentally opened or stuck open, the immobilization function is disabled and the vehicle can be operated normally but not immobilized, also not creating a safety risk. If the SAHR pressure goes to zero while the vehicle is moving, without a park brake engagement command, the valve closes, causing an emergency stop when the SAHR pressure decreases below the threshold. If the SAHR pressure goes to zero while the vehicle is standing still, the OH vehicle is immobilized.

The technical effect of immobilizing a vehicle using an immobilizer valve and SAHR brake integrated into an axle of the vehicle is that wheels of the vehicle may be prevented from moving in a safer, more robust, and more failsafe manner than other immobilization systems, due to an existing shielding of the axle and simplified electronic and hydraulic control.

FIG. 2 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

The disclosure also provides support for an immobilization system for a vehicle, comprising: a valve positioned on a hydraulic line supplying pressurized oil to a Spring applied Hydraulic Release (SAHR) braking mechanism of the vehicle, that when actuated to a closed position, prevents a pressure of the oil from releasing the SAHR braking mechanism, immobilizing the vehicle, wherein the valve is integrated inside an axle of the vehicle. In a first example of the system, the vehicle is an off-highway machine. In a second example of the system, optionally including the first example, the system further comprises: an electronic control board integrated inside the axle and electrically coupled to the valve, the electronic control board configured to actuate the valve in response to an electric signal from a controller of the vehicle. In a third example of the system, optionally including one or both of the first and second examples, the system further comprises: a second hydraulic line that connects the hydraulic line and the valve, such that in response to the pressure in the hydraulic line increasing above a threshold pressure, the pressure is applied to the valve via the second hydraulic line, the pressure maintaining the valve open. In a fourth example of the system, optionally including one or more or each of the first through third examples, the valve is actuated by a solenoid, the solenoid energized by the electronic control board. In a fifth example of the system, optionally including one or more or each of the first through fourth examples,: in a first, closed state of the valve, the pressurized oil is routed through a first chamber of the valve, through which the pressurized oil is blocked from passing, in a second, open state of the valve, the pressurized oil is routed through a second chamber through which the pressurized oil can pass, the valve is switched from the first, closed state to the second, open state when the solenoid is energized, the valve is maintained in the second, open state after the solenoid is de-energized by a pressure of the pressurized oil in the second hydraulic line, and the valve is switched from the second, open state to the first, closed state by a spring in response to the pressure decreasing below the threshold pressure. In a sixth example of the system, optionally including one or more or each of the first through fifth examples, activating the immobilization system includes leaving the valve in the closed position, and the immobilization system is released, permitting movement of the vehicle, by one of: a parking brake of the vehicle being disengaged, a key of the vehicle being recognized as valid, a control element of the vehicle being selected by an operator of the vehicle, and a signal being received at the vehicle via a wireless network. In a seventh example of the system, optionally including one or more or each of the first through sixth examples, instructions are stored in a memory of the electronic control board that when executed by a processor of the electronic control board, cause the processor to: when the immobilization system is activated: in response to receiving a valid unlock code from the electronic control board, energize the solenoid to actuate the valve to the second, open state to release the SAHR braking mechanism, and in response to the unlock code not being valid, maintain the valve in the first, closed state to maintain the vehicle immobilized. In a eighth example of the system, optionally including one or more or each of the first through seventh examples, instructions are stored in a memory of the controller that when executed, cause the controller to: in response to detecting a disengagement of a parking brake, the valve in the second, open state, increase a pressure of the oil above the threshold pressure, and in response to the pressure of the oil increasing above the threshold pressure, de-energizing the solenoid, the valve maintained in the second, open state by the pressure of the oil. In a ninth example of the system, optionally including one or more or each of the first through eighth examples, the unlock code comprises a sequence of electric signals of varying durations. In a tenth example of the system, optionally including one or more or each of the first through ninth examples, the controller is electrically coupled to the electronic control board via a circuit including a capacitor used to supply power to the electronic control board. In a eleventh example of the system, optionally including one or more or each of the first through tenth examples, the SAHR braking mechanism is configured to have a first braking torque that is higher than a second torque applied to the axle through a transmission of the vehicle, and/or higher than a maximum torque permissible by at least one element of the axle.

The disclosure also provides support for a method for a vehicle, the method comprising: in response to receiving an ignition signal, charging a capacitor of an electric circuit coupling a controller of the vehicle to an electronic control board of the vehicle to provide power to the electronic control board, detecting a disengagement of a parking brake of the vehicle at the controller, and in response, increasing a pressure of oil in a hydraulic line to a Spring applied Hydraulic Release (SAHR) braking mechanism of the vehicle locking one or more wheels of the vehicle and sending an electronic code to the electronic control board, determining a validity of the electronic code at the electronic control board, in response to the electronic code being valid, energizing a solenoid to actuate an immobilizer valve positioned on the hydraulic line to an open position, to allow a pressure of the oil to disengage the SAHR braking mechanism, and in response to the electronic code not being valid, not energizing the solenoid and maintaining the SAHR braking mechanism in an engaged state. In a first example of the method, the valve and the electronic control board are integrated inside an axle of the vehicle. In a second example of the method, optionally including the first example, the method further comprises: de-energizing the solenoid in response to the pressure of the oil increasing above a threshold pressure. In a third example of the method, optionally including one or both of the first and second examples, the method further comprises: sending an electric signal to prevent an operation of an engine of the vehicle over a controller area network (CAN) bus in response to detecting an ignition using an invalid key.

The disclosure also provides support for a valve positioned on a hydraulic line supplying pressurized oil to a Spring applied Hydraulic Release (SAHR) braking mechanism of a vehicle, the valve comprising: a first chamber where the pressurized oil is blocked from passing through the hydraulic line in a first, closed state of the valve, preventing a pressure of the oil from releasing the SAHR braking mechanism, the first, closed state of the valve immobilizing one or more wheels of the vehicle, a second chamber through which the pressurized oil is routed in a second, open state of the valve to release the SAHR braking mechanism, releasing the one or more wheels of the vehicle to move, a solenoid, that when energized, switches the valve from the first, closed state to the second, open state, and a second hydraulic line that connects the hydraulic line and the valve, such that in response to the pressure in the hydraulic line increasing above a threshold pressure, the pressure is applied to the valve via the second hydraulic line, the pressure maintaining the valve in the second, open state when the solenoid is not energized. In a first example of the system, the solenoid is energized by an electronic control board of the vehicle, the electronic control board and the valve integrated into an axle of a vehicle. In a second example of the system, optionally including the first example, instructions are stored in a memory of the electronic control board that when executed by a processor of the electronic control board, cause the processor to: in response to detecting a disengagement of a parking brake of the vehicle, increase a pressure of the pressurized oil, receive an unlock code from a controller of the vehicle, the unlock code a sequence of electric signals of varying durations, determine a validity of the unlock code, by comparing the sequence to a stored, predetermined sequence, in response to the unlock code being valid, energize the solenoid to actuate the valve to the second, open state to release the SAHR braking mechanism, in response to the unlock code not being valid, maintain the valve in the first, closed state to maintain the one or more wheels immobilized, and in response to the pressure of the pressurized oil increasing above a threshold pressure, de-energizing the solenoid. In a third example of the system, optionally including one or both of the first and second examples, the valve is actuated to the first, closed state in response to one of: the parking brake being engaged, a control element of the vehicle being selected by an operator of the vehicle, and a signal being received by the controller via a wireless network.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An immobilization system for a vehicle, comprising:
a valve positioned on a hydraulic line supplying pressurized oil to a Spring Applied Hydraulic Release (SAHR) braking mechanism of the vehicle, that when actuated to a closed position, prevents a pressure of the oil from releasing the SAHR braking mechanism, immobilizing the vehicle;
wherein the valve is integrated inside an axle of the vehicle.

2. The immobilization system of claim 1, wherein the vehicle is an off-highway machine.

3. The immobilization system of claim 1, further comprising an electronic control board integrated inside the axle and electrically coupled to the valve, the electronic control board configured to actuate the valve in response to an electric signal from a controller of the vehicle.

4. The immobilization system of claim 3, further comprising a second hydraulic line that connects the hydraulic line and the valve, such that in response to the pressure in the hydraulic line increasing above a threshold pressure, the pressure is applied to the valve via the second hydraulic line, the pressure maintaining the valve open.

5. The immobilization system of claim 4, wherein the valve is actuated by a solenoid, the solenoid energized by the electronic control board.

6. The immobilization system of claim 5, wherein:
in a first, closed state of the valve, the pressurized oil is routed through a first chamber of the valve, through which the pressurized oil is blocked from passing;
in a second, open state of the valve, the pressurized oil is routed through a second chamber through which the pressurized oil can pass;
the valve is switched from the first, closed state to the second, open state when the solenoid is energized;
the valve is maintained in the second, open state after the solenoid is de-energized by a pressure of the pressurized oil in the second hydraulic line; and
the valve is switched from the second, open state to the first, closed state by a spring in response to the pressure decreasing below the threshold pressure.

7. The immobilization system of claim 1, wherein activating the immobilization system includes leaving the valve in the closed position, and the immobilization system is released, permitting movement of the vehicle, by one of:
a parking brake of the vehicle being disengaged;
a key of the vehicle being recognized as valid;
a control element of the vehicle being selected by an operator of the vehicle; and
a signal being received at the vehicle via a wireless network.

8. The immobilization system of claim 6, wherein instructions are stored in a memory of the electronic control board that when executed by a processor of the electronic control board, cause the processor to:
when the immobilization system is activated:
in response to receiving a valid unlock code from the electronic control board, energize the solenoid to actuate the valve to the second, open state to release the SAHR braking mechanism; and
in response to the unlock code not being valid, maintain the valve in the first, closed state to maintain the vehicle immobilized.

9. The immobilization system of claim 8, wherein instructions are stored in a memory of the controller that when executed, cause the controller to:
in response to detecting a disengagement of a parking brake, the valve in the second, open state, increase a pressure of the oil above the threshold pressure; and
in response to the pressure of the oil increasing above the threshold pressure, de-energizing the solenoid, the valve maintained in the second, open state by the pressure of the oil.

10. The immobilization system of claim 8, wherein the unlock code comprises a sequence of electric signals of varying durations.

11. The immobilization system of claim 10, wherein the controller is electrically coupled to the electronic control board via a circuit including a capacitor used to supply power to the electronic control board.

12. The immobilization system of claim 1, wherein the SAHR braking mechanism is configured to have a first braking torque that is higher than a second torque applied to the axle through a transmission of the vehicle, and/or higher than a maximum torque permissible by at least one element of the axle.

13. A method for a vehicle, the method comprising:
in response to receiving an ignition signal, charging a capacitor of an electric circuit coupling a controller of the vehicle to an electronic control board of the vehicle to provide power to the electronic control board;
detecting a disengagement of a parking brake of the vehicle at the controller, and in response, increasing a pressure of oil in a hydraulic line to a Spring Applied Hydraulic Release (SAHR) braking mechanism of the vehicle locking one or more wheels of the vehicle and sending an electronic code to the electronic control board;
determining a validity of the electronic code at the electronic control board;
in response to the electronic code being valid, energizing a solenoid to actuate an immobilizer valve positioned on the hydraulic line to an open position, to allow a pressure of the oil to disengage the SAHR braking mechanism; and
in response to the electronic code not being valid, not energizing the solenoid and maintaining the SAHR braking mechanism in an engaged state.

14. The method of claim 13, wherein the valve and the electronic control board are integrated inside an axle of the vehicle.

15. The method of claim 13, further comprising de-energizing the solenoid in response to the pressure of the oil increasing above a threshold pressure.

16. The method of claim 13, further comprising sending an electric signal to prevent an operation of an engine of the vehicle over a controller area network (CAN) bus in response to detecting an ignition using an invalid key.

17. A valve positioned on a hydraulic line supplying pressurized oil to a Spring Applied Hydraulic Release (SAHR) braking mechanism of a vehicle, the valve comprising:
a first chamber where the pressurized oil is blocked from passing through the hydraulic line in a first, closed state of the valve, preventing a pressure of the oil from releasing the SAHR braking mechanism, the first, closed state of the valve immobilizing one or more wheels of the vehicle;
a second chamber through which the pressurized oil is routed in a second, open state of the valve to release the SAHR braking mechanism, releasing the one or more wheels of the vehicle to move;
a solenoid, that when energized, switches the valve from the first, closed state to the second, open state; and
a second hydraulic line that connects the hydraulic line and the valve, such that in response to the pressure in the hydraulic line increasing above a threshold pressure, the pressure is applied to the valve via the second hydraulic line, the pressure maintaining the valve in the second, open state when the solenoid is not energized.

18. The valve of claim 17, wherein the solenoid is energized by an electronic control board of the vehicle, the electronic control board and the valve integrated into an axle of a vehicle.

19. The valve of claim 18, wherein instructions are stored in a memory of the electronic control board that when executed by a processor of the electronic control board, cause the processor to:
in response to detecting a disengagement of a parking brake of the vehicle, increase a pressure of the pressurized oil;
receive an unlock code from a controller of the vehicle, the unlock code a sequence of electric signals of varying durations;
determine a validity of the unlock code, by comparing the sequence to a stored, predetermined sequence;
in response to the unlock code being valid, energize the solenoid to actuate the valve to the second, open state to release the SAHR braking mechanism;
in response to the unlock code not being valid, maintain the valve in the first, closed state to maintain the one or more wheels immobilized; and
in response to the pressure of the pressurized oil increasing above a threshold pressure, de-energizing the solenoid.

20. The valve of claim 19, wherein the valve is actuated to the first, closed state in response to one of:
the parking brake being engaged;
a control element of the vehicle being selected by an operator of the vehicle; and
a signal being received by the controller via a wireless network.
